(19) United States
(12) Patent Application Publication
(10) Pub. No.: US 2026/0102800 A1
(43) Pub. Date: Apr. 16, 2026

(54) MICROWAVE DESORPTION SYSTEM FOR SOIL

(71) Applicant: MEI LIN ENERGY TECHNOLOGY CO., Ltd., Kaohsiung City (TW)

(72) Inventors: Min-Hang Weng, Kaohsiung City (TW); Wu-Yeh Lee, Kaohsiung City (TW)

(73) Assignee: MEI LIN ENERGY TECHNOLOGY CO., Ltd., Kaohsiung City (TW)

(21) Appl. No.: 19/177,488

(22) Filed: Apr. 11, 2025

(30) Foreign Application Priority Data
Oct. 15, 2024 (TW) 113211183

(51) Int. Cl. B09C 1/06; B01D 53/00; B01D 53/44; B01D 53/76

(52) U.S. Cl. CPC B09C 1/06; B01D 53/007; B01D 53/44; B01D 53/76; B01D 2257/708; B01D 2258/02; B01D 2259/804

(57) ABSTRACT

A microwave desorption system for soil includes a rectangular housing, a microwave heating device, a gas treatment device, and an air extraction module. The microwave heating device is fixed to the rectangular housing and configured to heat a material with a moisture content ranging between 5% and 50% and a particle size not greater than 5 cm. The gas treatment device is fixed to the rectangular housing, connected to the microwave heating device, and equipped with multiple ultraviolet light sources. The ultraviolet light sources are configured to emit an ultraviolet light energy to directly decompose and purify a waste gas, so that a purified waste gas is released by the gas treatment device. The air extraction module is fixed to the rectangular housing, connected to the gas treatment device, and configured to extract the purified waste gas released by the gas treatment device out of the rectangular housing.

### CROSS-REFERENCE TO RELATED APPLICATION

This application claims priority to and the benefit of Taiwan Patent Application Ser. No. 113211183, filed on Oct. 15, 2024, the entirety of which is incorporated by reference herein.

### FIELD

The present disclosure relates to a desorption system for soil, and more particularly to a microwave desorption system that uses microwave heating to desorb contaminants from soil.

### BACKGROUND

Conventional heating methods, such as flame, hot air, electric heating, and steam, all rely on the principle of heat conduction to transfer heat from the outside to the inside of the heated object, gradually raising the temperature at the center of the heated object. In order to reach the desired temperature at the center of the object, a certain amount of time is required, and objects with poor thermal conductivity require even more time.

Microwaves are electromagnetic waves with frequencies ranging from 300 MHz to 300 GHz and commonly used for information transmission in radar and communication technologies. In recent years, microwaves have also been applied in various industrial and agricultural fields for heating, drying, or pyrolyzing materials. The power frequencies of the commonly used microwaves are 915 MHz and 2450 MHz, which can cause molecules of polar material to rub against each other to generate heat. The power frequency of the microwave can be selected according to the shape, size and moisture content of the heated material. Microwave heating makes the heated object itself become the heat source without the need for heat conduction, and the heating occurs simultaneously inside and outside, thus achieving the heating effect in a short time. Moreover, during microwave heating, electromagnetic waves typically penetrate evenly throughout all parts of the object to generate heat, thus significantly improving uniformity. In microwave heating, microwave energy is only absorbed by the heated object to generate heat while the air in the heating chamber and the corresponding container do not heat up, thus resulting in extremely high thermal efficiency and significantly improving production environments.

Since the waste gas generated after heating the material in the desorption system for soil needs to be purified before it can be discharged, the desorption system for soil typically requires various auxiliary devices, such as exhaust devices and gas treatment devices. That is, the microwave heating equipment needs to be integrated with peripheral equipment to complete the entire processing procedure. As a result, after the desorption process for a material is completed in a specific area, the microwave heating equipment and its peripheral equipment must be disassembled one by one, loaded by a heavy lifting machine onto vehicles such as trucks, transported to the next area for processing another material, and then unloaded and reassembled at the next area. The repeated process of disassembling, loading, transporting, unloading, and reassembling the microwave heating equipment and its peripheral equipment is necessary to process the materials.

In view of the above problems, it is necessary to provide a microwave desorption system for soil to solve the above problems.

### SUMMARY

The primary objective of the present disclosure is to provide a microwave desorption system for soil to solve the problem of the frequent need for movement that leads to the repeated process of disassembling, loading, transporting, unloading, and reassembling the microwave heating equipment and its peripheral equipment, particularly, when dealing with materials across multiple areas.

To achieve the above primary objective, the present disclosure provides a microwave desorption system for soil, which includes a rectangular housing, a microwave heating device, a gas treatment device, and an air extraction module. The microwave heating device is located inside and fixed to the rectangular housing and configured to heat a material with a moisture content ranging between 5% and 50% and a particle size not greater than 5 cm. The gas treatment device is located inside and fixed to the rectangular housing, connected to the microwave heating device, and equipped with multiple ultraviolet light sources for directly decomposing and purifying a waste gas generated after the microwave heating device heats the material, so that a purified waste gas is released by the gas treatment device. The air extraction module is located inside and fixed to the rectangular housing, connected to the gas treatment device, and configured to extract the purified waste gas released by the gas treatment device out of the rectangular housing.

According to one aspect of the present disclosure, the microwave heating device includes a heating chamber, a first microwave suppression chamber, a second microwave suppression chamber, a conveyor belt, and the exhaust module. The heating chamber has a feed opening and a discharge opening opposite to the feed opening and is equipped with microwave power sources to provide a microwave energy to heat the material. The first microwave suppression chamber is connected to the feed opening of the heating chamber and equipped with a first suppression structure configured to absorb the microwave energy from the feed opening. The second microwave suppression chamber is connected to the discharge opening of the heating chamber and is equipped with a second suppression structure configured to absorb the microwave energy from the discharge opening. The conveyor belt is configured to transport the material that needs to be heated by microwaves from a feed module into the first microwave suppression chamber, then into the heating chamber, and finally into the second microwave suppression chamber for outputting the material. The exhaust module is connected to a top of the heating chamber and configured to discharge the waste gas generated after heating the material out of the heating chamber to send the waste gas to the gas treatment device.

According to another aspect of the present disclosure, the gas treatment device is connected to the exhaust module of the microwave heating device via a pipe.

According to another aspect of the present disclosure, the first suppression structure is positioned over the conveyor belt and includes a first absorbing material for absorbing the microwave energy from the feed opening.

According to another aspect of the present disclosure, the first absorbing material is a ferrite material, a conductive polymer, or a carbon-based material.

According to another aspect of the present disclosure, the first suppression structure further includes a first microwave absorbing fluid for absorbing the microwave energy from the feed opening.

According to another aspect of the present disclosure, the second suppression structure is positioned over the conveyor belt and includes a second absorbing material for absorbing the microwave energy from the discharge opening.

According to another aspect of the present disclosure, the second absorbing material is a ferrite material, a conductive polymer, or a carbon-based material.

According to another aspect of the present disclosure, the second suppression structure further includes a second microwave absorbing fluid for absorbing the microwave energy from the discharge opening.

According to another aspect of the present disclosure, the inner space of the rectangular housing is a negative pressure environment.

According to another aspect of the present disclosure, the microwave heating device is electrically grounded to the rectangular housing via at least one metal sheet, and the rectangular housing is electrically grounded to the ground.

According to another aspect of the present disclosure, the at least one metal sheet is a copper sheet.

The present disclosure introduces a rectangular housing to carry the microwave heating equipment and its peripheral devices inside. After the process for material in an area is completed, an operator can directly use a heavy lifting machine to move the rectangular housing without moving the microwave heating equipment and its peripheral devices inside, thus effectively and quickly improving practical issues.

In summary, the microwave desorption system for soil according to the present disclosure has the following advantages:
1. The system is easy to transport and move with good mobility.
2. The system significantly saves time and manpower.
3. The system does not require repeated disassembly and assembly, thus enhancing system stability.
4. The purified gas is directly discharged.
5. A safe level of the microwave energy is achieved.

### BRIEF DESCRIPTION OF THE DRAWINGS

In order to make the above and other objectives, features, and advantages of the present disclosure more apparent and understandable, several preferred embodiments are described below in detail with reference to the accompanying drawings.

FIG. 1 is a schematic side view of a microwave desorption system for soil according to one embodiment of the present disclosure.

### DETAILED DESCRIPTION

Although the present disclosure can be embodied in different forms, the drawings and the descriptions herein are the preferred embodiments of the present disclosure. Those skilled in the art will understand that the devices and methods specifically described herein and illustrated in the drawings are considered as examples of the present disclosure and are not limiting exemplary embodiments, and the scope of the present disclosure is defined solely by the claims. The features illustrated or described in connection with one exemplary embodiment can be combined with features of other embodiments. Such modifications and variations will fall within the scope of the present disclosure.

Microwave heating technology is widely applicable in various fields, such as drying treatment before food processing, sludge drying treatment after food processing, industrial waste sludge decomposition and purification, organic soil remediation, etc. In the example of organic soil remediation, related treatment operations are often conducted in areas such as gas stations. Environmental protection operators need to set up microwave heating equipment and its peripheral devices at the gas stations to facilitate the remediation of organically contaminated soil. Particularly when dealing with materials across multiple regions, the frequent need for movement leads to the repeated process of disassembling, loading, transporting, unloading, and reassembling the microwave heating equipment and its peripheral equipment. The repeated process of disassembling, transporting, assembling, and calibrating the microwave heating equipment and its peripheral devices results in significant time and manpower consumption in practice. Therefore, a rectangular housing is introduced to carry the microwave heating equipment and its peripheral devices inside. After the process for material in an area is completed, an operator can directly use a heavy lifting machine to move the rectangular housing without moving the microwave heating equipment and its peripheral devices inside, thus effectively and quickly improving practical issues.

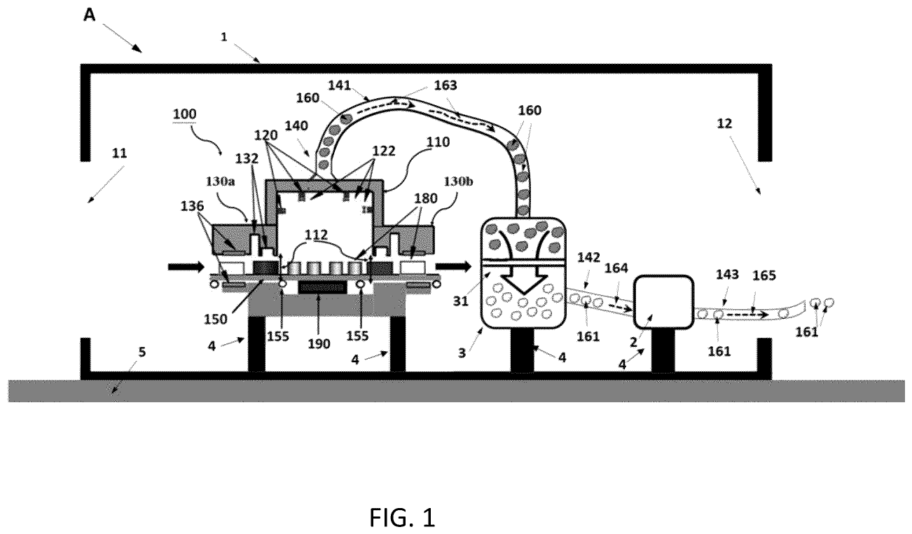

Now referring to FIG. 1, which is a schematic side view of a microwave desorption system A for soil according to one embodiment of the present disclosure. The microwave desorption system A for soil includes a rectangular housing 1, a microwave heating device 100, a gas treatment device 3, and an air extraction module 2. In one embodiment, the microwave heating device 100 includes a heating chamber 110, a first microwave suppression chamber 130a, a second microwave suppression chamber 130b, a conveyor belt 150, and an exhaust module 140. The microwave heating device 100 is configured to heat a material 180 with a moisture content ranging between 5% and 50% and a particle size not greater than 5 cm. The rectangular housing 1 is configured to carry the microwave heating device 100, the gas treatment device 3, and the air extraction module 2 inside and further includes an entrance structure 11 and an exit structure 12. The gas treatment device 3 is connected to the exhaust module 140 of the microwave heating device 100 and equipped with multiple ultraviolet light sources 31. The ultraviolet light sources 31 are configured to emit an ultraviolet light energy to directly decompose and purify a waste gas 160 generated after the microwave heating device 100 heats the material 180, so that a purified waste gas 161 is released by the gas treatment device 3. The waste gas 160 contains volatile organic compounds (VOCs). The air extraction module 2 is connected to the gas treatment device 3 and configured to extract the purified waste gas 161 released by the gas treatment device 3 out of the rectangular housing 1. In a decomposing and purifying process, the multiple ultraviolet light sources 31 irradiate the waste gas 160 to break chemical bonds of the volatile organic compounds or oxidize and decompose the volatile organic compounds, thereby discharging the purified waste gas 161.

The microwave heating device 100 is a batch-type microwave heating device or a continuous-type microwave heating device. The microwave heating device 100 is electrically grounded to the rectangular housing 1 via at least one metal structure 4, and the rectangular housing 1 is electrically grounded to the ground 5. The at least one metal structure 4 is a metal sheet, for example, particularly a copper sheet.

The heating chamber 110 is equipped with multiple microwave power sources 120 inside and has two openings 112, for example, one feed opening and one discharge opening opposite to the feed opening. The feed opening and the discharge opening are located respectively on two opposite sides of the heating chamber 110. More specifically, the feed opening is located at the left side of the heating chamber 110, and the discharge opening is located at the right side of the heating chamber 110. The height of each opening 112 is greater than 10 centimeters. The microwave power sources 120 provide a microwave energy 122 into the heating chamber 110 to heat the material 180, and the microwave frequency of the microwave power sources 120 is selected from one of 950 MHz, 2450 MHz, and 5800 MHz. Since the heating chamber 110 has two openings 112, the microwave energy 122 may leak out from the two openings 112 of the heating chamber 110. The first microwave suppression chamber 130a and the second microwave suppression chamber 130b are respectively connected to the heating chamber 110 at the positions where the openings 112 are located, and the first microwave suppression chamber 130a and the second microwave suppression chamber 130b are equipped with multiple microwave suppression structures configured to absorb the microwave energy 122 from the two openings. In the present embodiment, the multiple microwave suppression structures are positioned over the conveyor belt 150 and include at least one microwave absorbing material 132 and/or at least one microwave absorbing fluid 136. For example, the microwave suppression structure of the first microwave suppression chamber 130a may include a microwave absorbing material 132 and/or a microwave absorbing fluid 136, and the microwave suppression structure of the second microwave suppression chamber 130b may also include a microwave absorbing material 132 and/or a microwave absorbing fluid 136. The microwave absorbing material 132 can be a ferrite material, a conductive polymer, a carbon-based material, or any material that can absorb the microwave energy from the opening 112. The microwave absorbing fluid 136 can be any fluid (e.g., water) that can absorb the microwave energy from the opening 112 and can be positioned above and below the conveyor belt 150 through at least one fluid guiding pipe or fluid guiding channel provided by the microwave suppression structure.

The heating chamber 110 has two openings 112 to allow the conveyor belt 150 to pass through the heating chamber 110, and microwave heating device 100 further includes multiple rollers disposed under the conveyor belt 150 to support the conveyor belt 150. The conveyor belt 150 is configured to carry the material 180 to enter the microwave suppression chamber 130a, pass through one opening 112 (i.e., feed opening) of the heating chamber 110, traverse the heating chamber 110, and then exit through another opening 112 (i.e., discharge opening) of the heating chamber 110 to enter the microwave suppression chamber 130b. In the present embodiment, the conveyor belt 150 carries the material 180 to enter and traverse the heating chamber 110, so that the material 180 can be heated within the heating chamber 110. In addition, the conveyor belt 150 can be driven to move in a continuous conveying way or in a step-by-step conveying way. The continuous conveying way refers to moving forward at a fixed speed, and the step-by-step conveying way refers to moving forward a certain distance and then pausing for a period of time before the next movement. The thick black arrow in FIG. 1 indicates the moving direction of the material 180 carried by the conveyor belt 150. Since the heated material 180 is a large-volume item, the height of the opening 112 is designed to exceed 10 centimeters. The microwave heating device 100 further includes a support plate 190 disposed inside the heating chamber 110 and under the conveyor belt 150 to prevent the conveyor belt 150 from deforming due to the weight of the heated material 180 that has entered the heating chamber 110, which would cause uneven heating of the heated material 180.

The microwave power sources 120 provide a microwave energy 122 to the heating chamber 110 to heat the material 180. The material 180 is heated within the heating chamber 110 to generate gases, and the exhaust module 140 is configured to release the waste gas 160 generated by the heated material 180 from the heating chamber 110 to the gas treatment device 3. The dashed arrow 163 indicates the moving direction of the gases.

The gas treatment device 3 is connected to the exhaust module 140 of the microwave heating device 100 via a first pipe 141 and equipped with multiple ultraviolet light sources 31. The ultraviolet light energy emitted by the ultraviolet light sources 31 of the gas treatment device 3 directly decomposes and purifies the waste gas 160 generated after the microwave heating device 100 heats the material 180, so that a purified waste gas 161 is released by the gas treatment device 3.

The air extraction module 2 is connected to the gas treatment device 3 via a second pipe 142. The second pipe is configured to direct the purified waste gas 161 processed by the gas treatment device 3 toward the air extraction module 2 in the direction indicated by the dashed arrow 164. Then, the air extraction module 2 releases via a third pipe 143 the purified waste gas 161 outside the rectangular housing 1 in the direction indicated by the dashed arrow 165.

The microwave heating device 100, the gas treatment device 3, and the air extraction module 2 are located inside and fixed to the rectangular housing 1 by multiple metal structures 4, and the rectangular housing 1 is electrically grounded to the ground 5, so that the microwave heating device 100 and the rectangular housing 1 are electrically grounded.

The openings of the entrance structure 11 and the exit structure 12 of the rectangular housing 1 can be covered by cover structures (not shown). In addition, an air extraction component (not shown) is installed in the rectangular housing 1 to extract air from the interior of the rectangular housing 1, thereby creating a negative pressure environment inside the rectangular housing 1.

In summary, the microwave desorption system for soil according to the present disclosure has the following advantages:
1. The system is easy to transport and move with good mobility.
2. The system significantly saves time and manpower.
3. The system does not require repeated disassembly and assembly, thus enhancing system stability.
4. The outputted materials can be cooled quickly.
5. A safe level of the microwave energy is achieved.

Although the present disclosure has been disclosed in the preferred embodiments described above, these embodiments are not intended to limit the present disclosure. Any person skilled in the art can make various modifications and changes without departing from the spirit and scope of the present disclosure. As described above, various types of modifications and changes can be made without compromising the spirit of the present disclosure. Therefore, the scope of the present disclosure shall be defined by the appended claims.

What is claimed is:

1. A microwave desorption system for soil, comprising:
a rectangular housing;
a microwave heating device located inside and fixed to the rectangular housing and configured to heat a material with a moisture content ranging between 5% and 50% and a particle size not greater than 5 cm;
a gas treatment device located inside and fixed to the rectangular housing, connected to the microwave heating device, and equipped with a plurality of ultraviolet light sources, wherein the plurality of ultraviolet light sources are configured to emit an ultraviolet light energy to directly decompose and purify a waste gas generated after the microwave heating device heats the material, so that a purified waste gas is released by the gas treatment device; and
an air extraction module located inside and fixed to the rectangular housing, connected to the gas treatment device, and configured to extract the purified waste gas released by the gas treatment device out of the rectangular housing.

2. The system of claim 1, wherein the microwave heating device comprising:
a heating chamber having a feed opening and a discharge opening opposite to the feed opening, wherein the heating chamber is equipped with microwave power sources to provide a microwave energy to heat the material;
a first microwave suppression chamber connected to the feed opening of the heating chamber and equipped with a first suppression structure configured to absorb the microwave energy from the feed opening;
a second microwave suppression chamber connected to the discharge opening of the heating chamber and equipped with a second suppression structure configured to absorb the microwave energy from the discharge opening;
a conveyor belt configured to transport the material from a feed module into the first microwave suppression chamber, then into the heating chamber, and finally into the second microwave suppression chamber for outputting the material; and
an exhaust module connected to the heating chamber of the microwave heating device and configured to discharge the waste gas out of the heating chamber to send the waste gas to the gas treatment device.

3. The system of claim 2, wherein the gas treatment device is connected to the exhaust module of the microwave heating device via a pipe.

4. The system of claim 1, wherein the first suppression structure is positioned over the conveyor belt and includes a first absorbing material for absorbing the microwave energy from the feed opening.

5. The system of claim 4, wherein the first absorbing material is a ferrite material, a conductive polymer, or a carbon-based material.

6. The system of claim 4, wherein the first suppression structure further includes a first microwave absorbing fluid for absorbing the microwave energy from the feed opening.

7. The system of claim 4, wherein the second suppression structure is positioned over the conveyor belt and includes a second absorbing material for absorbing the microwave energy from the discharge opening.

8. The system of claim 7, wherein the second absorbing material is a ferrite material, a conductive polymer, or a carbon-based material.

9. The system of claim 7, wherein the second suppression structure further includes a second microwave absorbing fluid for absorbing the microwave energy from the discharge opening.

10. The system of claim 1, wherein an inner space of the rectangular housing is a negative pressure environment.

11. The system of claim 1, wherein the microwave heating device is electrically grounded to the rectangular housing via at least one metal sheet, and the rectangular housing is electrically grounded to a ground.

12. The system of claim 11, wherein the at least one metal sheet is a copper sheet.
